(19) United States
(12) Patent Application Publication
(10) Pub. No.: US 2016/0235076 A1
(43) Pub. Date: Aug. 18, 2016

(54) METHOD OF PREPARING A BIVALVE MOLLUSC

(71) Applicant: FISHERIES RESEARCH AND DEVELOPMENT CORPORATION, Deakin West (AU)

(72) Inventors: Stephen Luke PAHL, Mount Barker (AU); Robert SIMMONDS, Windsor Gardens (AU)

(21) Appl. No.: 15/025,249

(22) PCT Filed: Sep. 22, 2014
(86) PCT No.: PCT/AU2014/000928

§ 371 Date: Mar. 25, 2016

(30) Foreign Application Priority Data
Sep. 26, 2013 (AU) 2013903723

(51) Int. Cl. A22C 29/04; A47G 21/06

(52) U.S. Cl. CPC A22C 29/046; A47G 21/067; A23L 1/333; A47G 21/065; A23V 2002/00

(57) ABSTRACT

The present invention relates to bivalve molluscs and a method of preparing such molluscs so as to facilitate their subsequent opening. Specifically, the method includes exposing the interior of the mollusc and applying a seal to the exposed interior. The seal maintains the integrity of the mollusc prior to subsequent opening and provides an access point to facilitate subsequent opening of the mollusc. A tool for opening of the prepared mollusc is also encompassed by the present invention.

### PRIORITY CLAIM

This international patent application claims priority to Australian provisional patent application 2013903723 filed on 26 Sep. 2013, the contents of which are herein incorporated by reference.

### FIELD OF THE INVENTION

The present invention relates to bivalve molluscs and a method of preparing such molluscs so as to facilitate their subsequent opening. A tool for opening of the prepared mollusc is also encompassed by the present invention.

### BACKGROUND OF THE INVENTION

Bivalve molluscs belong to the bivalvia class of marine and freshwater molluscs which include, amongst others, oysters, mussels, clams, scallops and numerous other families of shells. Molluscs of this class generally comprise a shell having two similar valves which overlay a mantle connected to each valve. The valves are joined together along one edge by a flexible ligament that, in conjunction with interlocking teeth on each valve, forms a hinge. The hinge provides the ability for the shell of the mollusc to passively open and close without one valve physically separating from the other.

Active closure of the shell of a bivalve mollusc is achieved by contraction of the adductor muscle or muscles which are attached to the inner surface of both valves. The adductor muscle works in opposition to the ligament which tends to pull the valves apart. In sedentary or recumbent bivalves that lie on one valve, such as the oysters and the scallops, the anterior adductor muscle has been lost and the posterior muscle is positioned centrally. In file shells that can swim by flapping their valves, there is also a single, central adductor muscle. The adductor muscle is of considerable strength, and in the oyster for example can provide a continuous pull of around 9 kilograms for up to about 1 hour. Accordingly, a significant force is required to tear the adductor muscle from the valves.

The force required to separate each valve and expose the mollusc meat presents problems for suppliers, retailers and consumers alike. Removal of the adductor muscle from oysters and scallops for example, also referred to as “shucking”, has generally been a manual process. Typically, a knife blade is inserted through an opening near the hinge between the two valves and is used to cut the adductor muscle from the top valve. The top valve is then discarded, and the adductor muscle is cut from the bottom valve in a second cut. This type of manual shucking process can be quite physically demanding, and can lead to hand, wrist and repetitive strain injuries. Furthermore, insertion of a knife blade between each valve is complicated by the fact that the valves are tightly closed and the connecting portions of the valves at their ventral edges are of an irregular shape. This can lead to the knife blade slipping along the edge of the shell and cutting the user. In addition, manual shucking is time consuming and can lead to an inconsistency in the quantity and quality of the mollusc meat extracted, namely due to the amount of the adductor muscle that remains attached to the valves after shucking.

Other methods for removing mollusc meat from the shell include the use of various mechanical devices. One such device crushes or breaks the shell over substantial areas such as by impact of a pounding device. However, this method tends to generate small pieces of shell that infiltrate the meat present in the interior of the shell. These pieces of shell are difficult to remove and any remaining pieces of shell represent a potential health hazard for consumers.

With respect to the commercial supply of bivalve molluscs to retailers for subsequent consumer purchase, it would be advantageous to the consumer if the molluscs could be purchased in a state that enabled easy and efficient access to the mollusc meat so as to avoid the complications referred to above. However, due to the lag between supply and purchase the potential for contamination of the mollusc meat must be a factor of utmost consideration. In this regard, there exists a need for methods to prepare a bivalve mollusc for subsequent easy opening whilst maintaining the integrity of the mollusc meat prior to subsequent opening and ultimate consumption.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In addressing the aforementioned issues, the inventors have developed a method which enables the preparation of a bivalve mollusc for subsequent easy opening whilst maintaining the integrity of the mollusc meat prior to consumption.

Accordingly, in a first aspect the present invention provides a method of preparing a bivalve mollusc to facilitate subsequent opening of the mollusc, the method including: exposing the interior of the mollusc; and applying a seal to the exposed interior, wherein the seal maintains integrity of the mollusc prior to subsequent opening.

In one embodiment, the interior of the mollusc is exposed by removing a portion of the shell of the mollusc. For example, a portion of the shell of the mollusc can be removed by milling, grinding, drilling, nipping, cutting or slicing the shell.

In some embodiments, the interior of the mollusc is exposed at a region of the mollusc where each valve of the shell of the mollusc makes contact with each other. In one embodiment, the region of the mollusc where each valve of the shell of the mollusc makes contact with each other is the dorsal or posterior edge of each valve of the mollusc. In one embodiment, the dorsal or posterior edge of each valve of the mollusc is the dorsal or posterior edge located closest to the adductor muscle of the mollusc.

In some embodiments, the region of the mollusc where each valve of the shell of the mollusc makes contact with each other is not the hinge region of the mollusc.

In some embodiments, the interior of the mollusc is exposed via an opening of at least 1 mm.

In some embodiments, the seal minimises or eliminates leakage of liquor from the mollusc, prevents contamination of the mollusc, and/or maintains the shelf-life of the mollusc compared to an untreated mollusc.

In some embodiments, the seal is a wax-based seal. For example, the wax-based seal may include cheese-wax. In one embodiment, the wax-based seal also includes polyisobutylene. In one embodiment, the wax-based seal includes about 70% cheese-wax and about 30% polyisobutylene. In one embodiment, the polyisobutylene is Oppanol B12.

In some embodiments, the seal is applied while the exposed interior of the mollusc remains in a position which minimises or eliminates leakage of liquor from the interior of the mollusc.

In some embodiments, the wax-based seal is applied to the exposed interior of the mollusc in a molten state. In one embodiment, the wax-based seal is poured onto the exposed interior of the mollusc.

In some embodiments, the method further includes the step of applying a second seal over the seal that has been applied to the exposed interior of the mollusc. In one embodiment, the second seal is a wax-based seal. For example, the wax-based seal may include cheese-wax. In one embodiment, the wax-based seal also includes polyisobutylene. In one embodiment, the wax-based seal includes about 70% cheese-wax and about 30% polyisobutylene. In one embodiment, the polyisobutylene is Oppanol B12. In some embodiments, the second seal is applied in a molten state.

In some embodiments, the subsequent opening involves removing, piercing and/or breaking of the, or each, seal and insertion of a tool into the exposed interior of the mollusc, wherein the tool enables severing of the adductor muscle of the mollusc thereby allowing opening of the mollusc. In one embodiment, the tool can be used to leverage each valve of the shell of the mollusc apart prior to and/or after severing of the adductor muscle.

In some embodiments, a first portion of the tool includes a serration or sharpened edge for severing the adductor muscle. In one embodiment, the first portion of the tool is formed to encircle a portion of the adductor muscle. In one embodiment, the first portion of the tool is in the form of a hook which can encircle a portion of the adductor muscle. In one embodiment, the serration or sharpened edge is positioned on an inner portion of the hook which encircles a portion of the adductor muscle.

In some embodiments, a second portion of the tool includes a serration or sharpened edge for severing the mollusc from the adductor muscle. In one embodiment, the serration or sharpened edge can also be used to remove, pierce and/or break the, or each, seal prior to insertion of the tool into the exposed interior of the mollusc.

In some embodiments, a third portion of the tool includes means for assisting consumption of the mollusc. In one embodiment, the means includes a spoon-like or fork-like arrangement.

In some embodiments of the first aspect of the invention, the mollusc is selected from the group consisting of an oyster, a clam, a scallop and a mussel.

In a second aspect the present invention provides a bivalve mollusc prepared by the method of the first aspect of the invention.

In a third aspect the present invention provides a combination product including a bivalve mollusc prepared by the method of the first aspect of the invention, and a tool which can be inserted in the exposed interior of the mollusc, wherein the tool enables severing of the adductor muscle of the mollusc. In one embodiment, the tool can be used to leverage each valve of the shell of the mollusc apart prior to and/or after severing of the adductor muscle.

In some embodiments of the third aspect of the invention, a first portion of the tool includes a serration or sharpened edge for severing the adductor muscle. In one embodiment, the first portion of the tool is formed to encircle a portion of the adductor muscle. In one embodiment, the first portion of the tool is in the form of a hook which can encircle a portion of the adductor muscle. In one embodiment, the serration or sharpened edge is positioned on an inner portion of the hook which encircles a portion of the adductor muscle.

In some embodiments of the third aspect of the invention, a second portion of the tool includes a serration or sharpened edge for severing the mollusc from the adductor muscle. In one embodiment, the serration or sharpened edge can also be used to remove, pierce and/or break the, or each, seal prior to insertion of the tool into the exposed interior of the mollusc.

In some embodiments of the third aspect of the invention, a third portion of the tool includes means for assisting consumption of the mollusc. In one embodiment, the means includes a spoon-like or fork-like arrangement.

In a fourth aspect the present invention provides a tool for use in the method of the first aspect of the invention, wherein the tool can be inserted into the exposed interior of the mollusc and can severe the adductor muscle of the mollusc. In one embodiment, the tool can leverage each valve of the shell of the mollusc apart prior to and/or after severing of the adductor muscle.

In some embodiments of the fourth aspect of the invention, a first portion of the tool includes a serration or sharpened edge for severing the adductor muscle. In one embodiment, the first portion of the tool is formed to encircle a portion of the adductor muscle. In one embodiment, the first portion of the tool is in the form of a hook which can encircle a portion of the adductor muscle. In one embodiment, the serration or sharpened edge is positioned on an inner portion of the hook which encircles a portion of the adductor muscle.

In some embodiments of the fourth aspect of the invention, a second portion of the tool includes a serration or sharpened edge for severing the mollusc from the adductor muscle. In one embodiment, the serration or sharpened edge can also be used to remove, pierce and/or break the, or each, seal prior to insertion of the tool into the exposed interior of the mollusc.

In some embodiments of the fourth aspect of the invention, a third portion of the tool includes means for assisting consumption of the mollusc. In one embodiment, the means includes a spoon-like or fork-like arrangement.

### BRIEF DESCRIPTION OF THE FIGURES

For a further understanding of the aspects and advantages of the present invention, reference should be made to the following detailed description, taken in conjunction with the accompanying drawings.

FIG. 1—A diagrammatic representation of the anatomy of a bivalve mollusc as depicted by an oyster. The oyster is shown in the left valve indicating cardinal axes and digestive system including labial palps and gills. Figure redrawn from Galtsoff, 1964, “The American Oyster Crassostrea virginica Gmelin.”, Fishery Bulletin, volume 64, United States Government Printing Office Washington D.C. iii+480p, as depicted in Eble AF and Scro R, 1996, General Anatomy, In: Kennedy V S, Newell RIE and Eble AF (eds), “The Eastern Oyster Crassostrea virginica”, Maryland Sea Grant College Publishers, College Park, Md., p 19-73.

FIG. 2—a photograph showing the position of the ground opening of an oyster shell as prepared for Study 1.

FIG. 3—a photograph showing a bottle wax seal applied to the ground opening of an oyster shell as prepared for Study 1. The presence of a tag is also shown.

FIG. 4—a photograph showing the position of the ground opening of an oyster shell as prepared for Study 3.

FIG. 5—a photograph showing a PVAc seal applied to the ground opening of an oyster shell as prepared for Study 4.

FIG. 6—a photograph showing a shrink-wrap seal applied to the ground opening of an oyster shell as prepared for Study 5.

FIG. 7—a photograph showing the presence of a gape in an Oppanol B12 (100%) seal applied to the ground opening of an oyster shell as prepared for Study 8.

FIG. 8—a photograph showing the presence of a gape in a paraffin wax (5%):Oppanol B12 (95%) seal applied to the ground opening of an oyster shell as prepared for Study 8.

FIG. 9—a graph summarising the sealing performance of a range of sealing materials applied to the ground opening of an oyster shell as prepared for Study 9. Performance was measured according to weight loss of the oyster after 7 days. ** indicates that the oyster leaked.

FIG. 10—a photograph showing a silicon bakeware seal held in place by a rubber band as applied to the ground opening of an oyster shell prepared for Study 11.

FIG. 11—a photograph showing a seal consisting of GD31 gluedots held in place with backing paper and a rubber band as applied to the ground opening of an oyster shell prepared for Study 11.

FIG. 12—a photograph showing the ground opening of an oyster sealed with a two-stage Oppanol B12-wax treatment as applied to the ground opening of an oyster shell prepared for Study 11.

FIG. 13—a photograph showing the size of an opening (about 15 mm×about 1 mm) ground in the shell of an oyster prepared for Study 16.

FIG. 14—a photograph showing the size of an opening (about 27 mm×about 2.5 mm) ground in the shell of an oyster prepared for Study 16.

FIG. 15—a depiction of a tool according to one embodiment of the present invention (FIG. 15A). FIGS. 15B and 15C depict the action and position of the tool with respect to an oyster.

### DETAILED DESCRIPTION OF THE INVENTION

The present invention is predicated in part on the recognition that there exists a need for a method to prepare a bivalve mollusc so as to enable the mollusc to be easily opened prior to consumption but without compromising the integrity of the mollusc meat prior to consumption.

Accordingly, in a first aspect the present invention provides a method of preparing a bivalve mollusc to facilitate subsequent opening of the mollusc, the method including:

exposing the interior of the mollusc; and

applying a seal to the exposed interior,

wherein the seal maintains integrity of the mollusc prior to subsequent opening.

In general, the method of preparing the bivalve mollusc would be performed prior to retail sale of the mollusc. The method would therefore commonly be carried out by the supplier and/or distributor of the mollusc with the subsequent opening performed by the retailer or consumer.

As used herein, the term “exposing the interior of the mollusc” is taken to mean creating an opening in the shell of the mollusc whereby the internal cavity of the mollusc is no longer fully protected and encased by the shell. The purpose of exposing the interior is to allow subsequent insertion of a tool or device into the opening which enables leveraging of the valves of the shell away from each other and/or severing of the adductor muscle or muscles of the mollusc.

The interior of the mollusc may be exposed using any appropriate method, for example by removing a portion of the shell of the mollusc. However, the method chosen preferably should not shatter the shell which has the tendency to generate small pieces of shell that infiltrate the meat present in the interior of the shell.

In one embodiment, a portion of the shell of the mollusc may be removed by milling the shell. Milling is a process by which rotary cutters are used to shave the relevant section of the shell away. Typically, a milling cutter is spun about an axis while the shell of the mollusc is advanced through it in such a way that the blades of the cutter are able to shave portions of shell with each pass. The milling process is designed so that the cutter makes many individual cuts on the shell in a single run. This can be accomplished by using a cutter with many teeth, spinning the cutter at high speed, and/or slowly advancing the shell of the mollusc through the cutter.

Alternatively, a portion of the shell of the mollusc may also be removed by grinding the shell. Grinding is more imprecise than milling but is amendable to the use of more portable, including hand-held, devices. Typical grinding devices will act by wearing down a portion of the shell by friction created between an abrasive wheel of the device and the surface of the shell.

In another method, a portion of the shell of the mollusc may be removed by nipping the shell at the desired location. Nipping tools are typically used to remove portions from the ventral edge or lip of the shell. Nippers can generally be divided into two classes. The first class relies on a plier or nut cracker type arrangement defining two jaw elements which are mechanically moved towards each other, usually with some mechanical leverage, to remove a portion of the mollusc shell lip. The second class is defined by rotary type nipping devices wherein a nipping element rotates continuously to impart mechanical efficiency.

Other methods for removing a portion of the shell of the mollusc would be known in the art. For example, drilling may be employed to bore a precise hole in the shell at the desired location. The shell may also be cut or sliced at the desired location.

Using any one of the methods referred to above, the interior of the mollusc may, in one embodiment, be exposed at a region of the mollusc where each valve of the shell of the mollusc makes contact with each other. In this manner, the interior is exposed at the extreme peripheral region or edge of the mollusc shell.

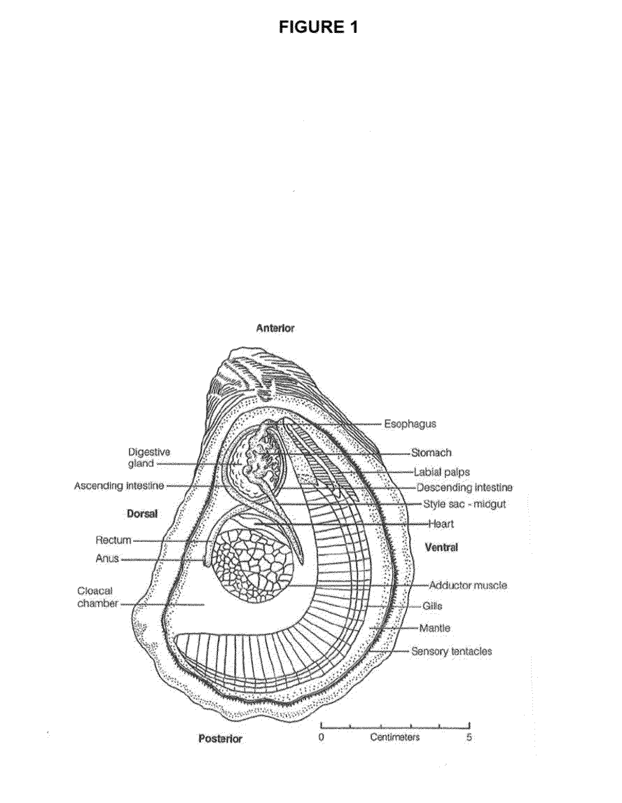

In one embodiment, the region of the mollusc where each valve of the shell of the mollusc makes contact with each other is the dorsal or posterior edge of each valve of the mollusc. The location of the dorsal and posterior regions of the mollusc is defined by basic anatomical referencing as would be understood by a person skilled in the art and as outlined in FIG. 1. In one embodiment, the dorsal and posterior regions targeted for exposing the interior of the mollusc are those regions of the mollusc which are located closest to the adductor muscle or muscles of the mollusc. The advantage of exposing the interior at one of these regions is to allow access to adductor muscle of the mollusc with minimal disruption to the mollusc meat. This is described in further detail below.

In an alternative embodiment, the region of the mollusc where each valve of the shell of the mollusc makes contact with each other is the ventral or posterior edge of each valve of the mollusc. In one embodiment, the ventral and posterior regions targeted for exposing the interior of the mollusc are those regions of the mollusc which are located furthest from the adductor muscle or muscles of the mollusc. The advantage of exposing the interior at one of these regions is to allow maximum leverage capability when subsequent separation of the two valves is attempted by the consumer before the adductor muscle is severed.

In light of the aforementioned locations, the region of the mollusc where each valve of the shell of the mollusc makes contact with each other is not the hinge region of the mollusc.

The method used to expose the interior of the mollusc will lead to the creation of an opening in the shell of the mollusc. Ideally, the opening will be of a size of about at least 1 mm so as to allow access to the interior of the mollusc as described in further detail below. The size of the opening will in part be dictated by the method used to remove a portion of the shell. Methods which rely on drilling a hole in the shell will allow the generation of an opening with a defined size based on the diameter of the drill bit; however, methods such as milling and grinding will lead to generation of an opening with varying sizes. Furthermore, due to the nature of the shape of the mollusc, methods such as milling and grinding will produce an opening in a longitudinal plane such that the length of the opening will be larger than the width. However, in this instance, the width of the opening should be at least 1 mm.

As described in the examples below, the ability of liquor in the mollusc to form a sealing meniscus decreases as the size of the opening increases. Loss of liquor can be detrimental to the longevity of the internal mollusc meat. Accordingly, it is ideal that the opening is of a size no larger than that needed to adequately accommodate a tool for separating the valves from each other, as described in detail below. In one embodiment, the opening may be of a size or width in a range of at least about 1 mm, as referred to above, to at least about 5 mm. For example, the size or width of the opening may be at least about 1.5 mm, at least about 2.0 mm or at least about 2.5 mm. When grinding or milling procedures are used, the length of the opening may be in a range of at least about 10 mm to at least about 50 mm. For example, the length of the opening may be at least about 15 mm, at least about 20 mm, at least about 25 mm, at least about 26 mm, at least about 27 mm, at least about 28 mm, at least about 29 mm, or at least about 30 mm.

The term “about” as used herein means approximately or nearly and in the context of a numerical value or range set forth herein is meant to encompass variations of +/−10% or less, +/−5% or less, +/−1% or less, or +/−0.1% or less of and from the numerical value or range recited or claimed.

Once the interior of the mollusc has been exposed, the method of the first aspect of the invention requires the application of a seal to the exposed interior. The primary purpose of the seal is to maintain the integrity of the mollusc prior to subsequent opening by the consumer. In the context of the present invention, the “integrity” of the mollusc is maintained if it retains the same or comparable characteristics as that of a “wild-type” mollusc of the same species, i.e. a mollusc that has not been treated with method of the first aspect of the invention. In one embodiment, suitable measures of the ability of a seal to maintain the integrity of the mollusc include, but are not limited to, minimising or eliminating leakage of liquor from the mollusc, preventing contamination of the mollusc from external sources, and/or maintaining the shelf-life of the mollusc compared to an untreated mollusc.

The seal may comprise any suitable sealing material. In one embodiment, the seal may be formed of a sufficiently malleable material so that the seal is capable of conforming to the shape of the shell of the mollusc. For example, the sealing material may be a viscous fluid, a fluid-like substance, a semi-solid substance, and the like. The sealing material must be recognised as being suitable for at least incidental contact with food according to relevant safety standards and legislative requirements. In the context of the present invention, the term “at least incidental contact” includes the seal coming into contact with at least the liquor of the mollusc. Examples of relevant safety standards include the United States Federal Food, Drug, and Cosmetic Act (Title 21 of the Code of Federal Regulations) standards for being generally recognized as safe (GRAS), the Food Standards Australia and New Zealand Food Standards Code (e.g. standards 1.4.1 and 1.4.3), the Australian Standard AS2070-1999 for plastic materials, and the European Commission directives for materials and articles intended to come into contact with foodstuffs as set out by Commission Directives 89/209/EEC (Framework Directive) and 90/128/EEC and their subsequent amendments or revisions, including 82/711/EEC and 85/572/EEC.

Examples of suitable sealing material for the seal would be known in the art and may include, but are not limited to, waxes, gums, plastics, resins, rubbers, polymers and the like.

As would be understood by a person skilled in the art, waxes belong to a class of chemical compounds that are malleable near ambient temperatures. Characteristically, waxes melt above 45° C. to give a low viscosity liquid. Waxes are hydrophobic but are soluble in organic, nonpolar solvents. All waxes are organic compounds which are both synthetic and naturally derived. Natural waxes, such as plant and animal waxes are typically esters of fatty acids and long chain alcohols. Synthetic waxes, such as petroleum derived waxes (e.g. paraffin and microcrystalline waxes) are long-chain hydrocarbons lacking functional groups.

Suitable waxes for the sealing material may include any of various hydrocarbons (straight or branched chain alkanes or alkenes, ketone, diketone, primary or secondary alcohols, aldehydes, sterol esters, alkanoic acids, turpenes, monoesters), such as those having a carbon chain length ranging from C₁₂-C₃₈. Also suitable are diesters or other branched esters. The compound may be an ester of an alcohol (glycerol or other than glycerol) and a C₁₈ or greater fatty acid.

In some embodiments of the present invention, the wax is selected from one or more of the group consisting of cheese wax (e.g. Sonneborn cheese-wax), mineral/petroleum derived waxes such as paraffin, beeswax (e.g. White Beeswax SP-422P available from Strahl and Pitsch of West Babylon, N.Y.), Chinese wax, lanolin, shellac wax, spermaceti, bayberry wax, candelilla wax, vegetable waxes such as carnauba wax, insect wax, castor wax, esparto wax, Japan wax, jojoba oil, ouricury wax, rice bran wax, soy wax, lotus wax (e.g., Nelumbo Nucifera Floral Wax available from Deveraux Specialties, Silmar, California), ceresin wax, montan wax, ozocerite, peat waxes, microcrystalline wax, petroleum jelly, Fischer-Tropsch waxes, substituted amide waxes, cetyl palmitate, lauryl palmitate, cetostearyl stearate, polyethylene wax (e.g. PERFORMALENE 400, having a molecular weight of 450 and a melting point of 84° C., available from New Phase Technologies of Sugar Land, Tex.), silicone waxes such as C₃₀₋₄₅ Alkyl Methicone and C₃₀₋₄₅ Olefin (e.g. Dow Corning AMS-C30, having a melting point of 70° C., available from Dow Corning of Midland, Mich.).

Mixtures of the aforementioned waxes are also contemplated by the present invention. For example, the seal may include a mix of paraffin and microcrystalline wax which is the base constituents of cheese-wax.

Gums are polysaccharides that are generally malleable at ambient temperatures or upon heating. Suitable gums for use in the present invention include, but are not limited to, agar (E406), alginic acid (E400), sodium alginate (E401), carrageenan (E407), gum arabic (E414) from the sap of Acacia trees, gum ghatti from the sap of Anogeissus trees, gum tragacanth (E413) from the sap of Astragalus shrubs, karaya gum (E416) from the sap of Sterculia trees, guar gum (E412) from guar beans, locust bean gum (E410) from the seeds of the carob tree, beta-glucan from oat or barley bran, chicle gum from the chicle tree, dammar gum from the sap of Dipterocarpaceae trees, glucomannan (E425) from the konjac plant, mastic gum from the mastic tree, psyllium seed husks from the Plantago plant, spruce gum from spruce trees, tara gum (E417) from the seeds of the Tara tree, gellan gum (E418), xanthan gum (E415), and mixtures thereof.

Any non-biodegradable thermoplastic polymer may be used as a sealing material in the present invention provided that it satisfies the sealing requirements described herein. Those which are softened or in a molten form from about 120° C. to about 260° C. are most convenient in terms of reducing energy costs when preparing and applying the seal. Such polymers would be known in the art, and include, but are not limited to, polyethylene (including low density polyethylene (LDPE) but excluding high density polyethylene (HDPE)), polypropylene, acrylic, polyvinyl ethylene, polyvinyl acetate, polyvinyl chloride (PVC), polystyrene, nylon, polybutadiene, polyisobutylene, and mixtures thereof.

Polyethylene is an inert thermoplastic polymer with a melting temperature dictated by its density. Therefore, melting temperatures can range from 105° C. (for lower density polyethylene) to 130° C. (for higher density polyethylene). Polyethylene is classified into several different categories based on characteristics such as its density and branching. Its mechanical properties depend significantly on variables such as the extent and type of branching, the crystal structure and the molecular weight. When categorised according to density, polyethylene exists in a number of forms, the most common being high density polyethylene (HDPE), linear low density polyethylene (LLDPE), and low density polyethylene (LDPE). HDPE is defined by a density of greater or equal to 0.941 g/cm³.

LLDPE is defined by a density range of 0.915-0.925 g/cm³. LLDPE is a substantially linear polymer with significant numbers of short branches, commonly made by copolymerization of ethylene with short-chain alpha-olefins (for example, 1-butene, 1-hexene and 1-octene). LLDPE has higher tensile strength than LDPE, and exhibits a higher impact and puncture resistance than LDPE. LLDPE is commonly used in packaging, particularly film for bags and sheets, saran wrap, and bubble wrap.

LDPE is defined by a density range of 0.910-0.940 g/cm³. LDPE has a high degree of short and long chain branching, which means that the chains do not pack into the crystal structure as well. It has, therefore, less strong intermolecular forces as the instantaneous-dipole induced-dipole attraction is less. This results in a lower tensile strength and increased ductility. The high degree of branching with long chains gives molten LDPE unique and desirable flow properties. LDPE is most commonly used for manufacturing various containers, dispensing bottles, wash bottles, tubing, and plastic bags for computer components. However, its most common use is in plastic bags.

In crude forms, the seal may be formed by the use of saran wrap, shrink wrap, paper (e.g. wax paper) or cloth, or other like materials (e.g. silicon bakeware), held in place over the exposed interior of the mollusc by a band or tie. Alternatively, self-adhesive labels or pressure sensitive adhesive may be used provided that they satisfy the sealing requirements.

In some embodiments, the seal is a wax-based seal. In one embodiment, the wax-based seal includes cheese-wax. Various cheese-waxes are available for purchase from commercial sources. These include Sonneborn, Sasol Wax, and Paramelt.

In some instances, it may be desirable that the seal is comprised of a mixture of the above-referenced sealing materials. One reason for combining sealing materials is to increase the adherence properties of the seal to the shell of the mollusc or to minimise cold flow once applied to the shell. For example, a wax may be combined with a polymer/rubber such as polyisobutylene (Oppanol B). Accordingly, in some embodiments, the seal is wax-based seal that includes a combination of cheese-wax and polyisobutylene. Suitable sealing material combinations could easily be prepared and tested by a person skilled in the art.

In seals which comprise a combination of sealing materials, the relevant proportions of each material in the seal can be optimised taking into account the need for the seal to adhere to the shell of the mollusc and the requirement that the seal maintains the integrity of the mollusc. As an example, where a combination of cheese-wax and polyisobutylene forms the basis of the seal, the following percent combinations may be employed—about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, 45:55, 40:60, 35:65, 30:70, 25:75, 20:80, 15:85, 10:90, and 5:95 (cheese-wax:polyisobutylene).

In one embodiment, the seal includes about 70% cheese-wax and about 30% polyisobutylene. In one embodiment, the polyisobutylene is Oppanol B12.

As discussed above, to maintain the integrity of the mollusc during the preparation method, loss of liquor from the interior of the mollusc should be minimised. Accordingly, it is preferred that the seal is applied while the exposed interior of the mollusc remains in a position which minimises or eliminates leakage of liquor. Generally, this will require the mollusc to be positioned such that the exposed interior of the mollusc is above the horizontal plane prior to and during application of the seal. However, if the seal is to applied when the exposed interior of the mollusc is below the horizontal plane, shaking or rapid movement of the mollusc should be avoided as best as possible to minimise disruption of the sealing meniscus and subsequent loss of liquor from the mollusc.

The seal may be applied in any manner of ways. Applications may include, but are not limited to, pouring, spraying, brushing, dipping or injecting the seal. In instances where the seal is a waxed-based seal, such as a cheese-wax seal, the seal can be readily applied in a molten state by pouring the molten seal over the exposed interior of the mollusc. Alternatively, the mollusc can be dipped into the molten wax.

In some instances, the method of the first aspect of the invention may further include the step of applying a second seal over the seal that had been applied to the exposed interior of the mollusc. The second seal essentially acts as a further barrier towards maintaining the integrity of the mollusc during subsequent handling and distribution, and before ultimate opening and consumption of the mollusc. The second seal may be any one of those described above, and may be applied using any one of the methods described herein. Furthermore, the second seal may comprise a combination of sealing materials as referred to above. In one embodiment, the second seal is identical in composition to the first seal. Accordingly, in one embodiment the second seal is a wax-based seal, for example one including a cheese-wax. The wax-based seal may further include polyisobutylene such as Oppanol B12.

The seal may also act as a brand or supplier identifier by being colour coded or by being embossed with the brand or supplier details. In effect, this allows the prepared mollusc to be distinguished by origin, quality and/or type. The seal may also serve as a substrate for application of a label which can provide brand or supplier information. The label may also serve to identify the origin and type of oyster, and a consume-by date either in written form or via a bar code identifier.

If the method of the present invention is performed at the supplier or distributor premises, once the exposed interior of the mollusc has been sealed the mollusc is then in a form ready for distribution to a retailer or direct to the consumer and subsequent opening by the retailer or consumer. The process of opening the prepared mollusc is now simplified for the retailer or consumer compared to opening a mollusc that has not been prepared by the method of the present invention. In this regard, the sealed opening acts as an access point for insertion of a tool into the interior of the mollusc to sever the adductor muscle and/or leverage each valve of the shell of the mollusc apart. The seal or seals can be pierced by the tool, or the seal or seals can be broken or entirely removed thereby enabling the tool to be inserted into the interior of the mollusc. An appropriate tool would be well known in the art and an exemplary embodiment is described in detail below.

In one embodiment, the seal may include a feature which assists in the part or complete removal of the seal prior to insertion of the tool. For example, the seal may include a tag or tie which when lifted or pulled takes a part of the seal, or the entire seal, with it. The tag or tie may be made of any material recognised as being suitable for at least incidental contact with food according to relevant safety standards and legislative requirements, as described above. The tag or tie may also serve as a brand or supplier identifier by being colour coded or shaped appropriately. The tag or tie may also serve to identify the origin and type of oyster, and a consume-by date.

As used herein, the term “mollusc” encompasses any bivalve shellfish of the phylum Mollusca. Relevant subclasses include Heterodonta, Palaeoheterodonta, Protobranchia, Pteriomorpha, Anomalodesmata, Rostroconchia. The most familiar of these subclasses is the Pteriomorpha, a group that includes animals such as oysters, mussels, clams, scallops and cockles. In some embodiments, the mollusc is an oyster.

In a second aspect, the present invention provides a bivalve mollusc prepared by a method of the first aspect of the invention. The prepared mollusc can be easily distinguished from molluscs which have not been prepared by a method of the invention due to the presence of the seal which has been applied to the exposed interior of the mollusc.

In a third aspect, the present invention provides a combination product including a bivalve mollusc prepared by the method of the first aspect of the invention, and a tool which can be inserted in the exposed interior of the mollusc, wherein the tool enables severing of the adductor muscle or muscles of the mollusc. An exemplary embodiment of the tool is described in detail below.

In a fourth aspect, the present invention provides a tool for use in the method of the first aspect of the invention. The tool may be of a knife-like or needle-like conformation that can pass into the opening of the shell at the exposed interior.

In one embodiment, the tool can be inserted into the exposed interior of the mollusc and can sever the adductor muscle or muscles of the mollusc. In order to do this, the tool may include a serration or sharpened edge on a first portion of the tool that is inserted into the mollusc. In one embodiment, this first portion of the tool may be formed to encircle the adductor muscle such that the serrated or sharpened edge on this portion of the tool contacts the adductor muscle allowing it to be severed, thereby releasing one valve of the mollusc. In one embodiment, this portion of the tool is in the form of a hook which encircles a portion of the adductor muscle.

In one embodiment, the rigidity of the tool must be sufficient for allowing leveraging of each valve of the shell apart without the tool breaking or bending to a point of inactivity. In this regard, the tool will typically be constructed of a plastic or metal material, provided the material is recognised as being suitable contact with food according to relevant safety standards and legislative requirements. In one embodiment, the tool can leverage each valve of the shell of the mollusc apart after severing the adductor muscle, or can be used to leverage each valve of the shell of the mollusc apart without severing the adductor muscle.

In some embodiments, a second portion of the tool may include a serration or sharpened edge for severing the adductor muscle from the mollusc meat attached to the remaining valve of the shell of the mollusc. However, it would be understood that this task could be equally performed by the serration or sharpened edge on the first portion of the tool in the absence of a serration or sharpened edge on a second portion of the tool. In some embodiments, the serration or sharpened edge on the first and/or second portions of the tool can also be used to remove, pierce and/or break the, or each, seal prior to insertion of the tool into the exposed interior of the mollusc.

In some embodiments, a third portion of the tool may include means for assisting consumption of the mollusc meat once released from the adductor muscle. Typically, the third portion will be a spoon-like or fork-like arrangement.

It will be apparent to the person skilled in the art that while the invention has been described in some detail for the purposes of clarity and understanding, various modifications and alterations to the embodiments and methods described herein may be made without departing from the scope of the inventive concept disclosed in this specification.

The invention is further illustrated in the following examples. The examples are for the purpose of describing particular embodiments only and are not intended to be limiting with respect to the above description. Whilst the present invention is not limited to oysters, the following examples are based on use of oysters as one embodiment to demonstrate the utility of the method of the invention. It would be clearly understood that bivalve molluscs in general share the same basic anatomy and that the method of the invention could be equally practiced on other members of the bivalve mollusc family.

### EXAMPLE 1

### Anatomy of the Oyster

The basic structure of a bivalve mollusc, as demonstrated through the oyster, is shown in FIG. 1. The shell of the oyster consists of two calcerous valves joined by a resilient hinge ligament. The two valves of the shell are assymetrical with the left being larger and more deeply cupped than the right. The internal organs of the oyster are covered with a fleshy fold of tissue called the mantle or pallium. The mantle is always in contact with the valves but is not attached to them. The large central cavity bounded by the mantle lobes is the pallial cavity which contains the palps and gills on the ventral side and the rectum on the dorsal side. The pallial cavity is subdivided into two cavities. The first cavity (epibranchial chamber) is formed by the fusion of the mantle dorsally with the visceral mass and ventrally with the bases of the gills. The second large cavity (hypobranchial chamber) contains the gills and is bounded by the two mantle lobes. The adductor muscle is an organ situated in the posterior region of the body and is composed of an anterior larger part and a smaller crescent-shaped region. The adductor muscle functions to close the shell. Upon relaxation of the adductor muscle the valves are allowed to gape because of the resiliency of the hinge ligament.

### EXAMPLE 2

### Proof of Concept Studies

The following proof on concept studies were undertaken to test the validity of the method of the present invention. The studies focussed on grinding of an oyster shell as an embodiment of exposing the interior of the oyster followed by sealing with a range of sealing materials. The incorporation of a section of a cable tie acting as a tag was also trialled. Throughout the studies the oysters were evaluated at the end of a typical shelf life of unopened oysters, namely approximately 8 days. After approximately 8 day's storage, the oysters were evaluated according to the following aspects:
Evaluation of the physical condition of unopened oysters
   a. Has the oyster opened up during storage? (Yes/No)
   b. Has the tag remained attached (prior to opening)? (Yes/No)
   c. Measure the ease of removal of the tag and adhesive (Easy/Moderate/Hard)
   d. Measure the ease of shucking (Easy/Moderate/Hard)
Evaluation of the condition of oysters once opened
   a. Water present in the oyster (Yes/No)
   b. Is there loose shell, grit (ground/chipped) within the oyster cavity? (Yes/No)
   c. Is there adhesive within the oyster cavity? (Yes/No)
   d. Does the oyster look burnt or damaged? (Yes/No)
   e. Sensory evaluation of the oysters; odour, body colour, liquor (Score 1-4).

### Study 1

This study was carried out to test the grinding method with cable tie insertion (as tag analogue) and effectiveness of resealing the opening with bottle sealing wax (Lordell Trading).

### Method

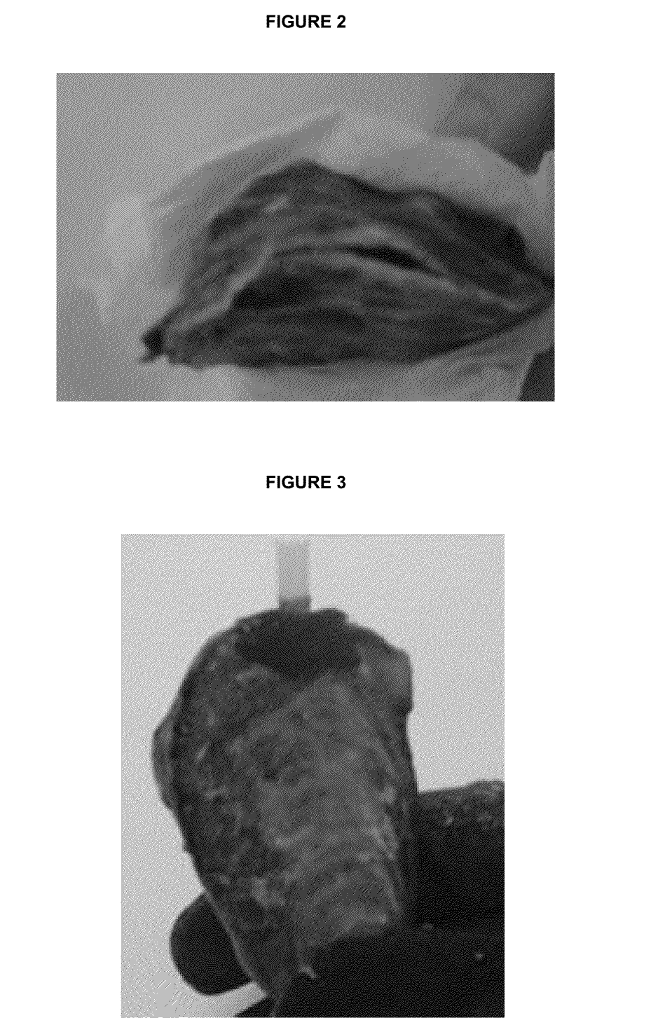

The oyster shell was ground until a small hole was achieved at the region between the two valves of the shell of the oyster opposite the hinged area of the oyster shell, i.e. the posterior end of the shell of the oyster (FIG. 2). The hole was approximately 5 mm×2 mm, just large enough to insert the cable tie (FIG. 3). During this process the shell was held with the hole topmost so that the oyster liquor would not leak out. The wax was melted by cutting off a small portion from a raw material block and placing it into a stainless steel bowl which was then placed over a pot of boiling water. Once molten, the wax was applied (with a brush) to the shell around the ground opening to fix the cable tie in place and seal the opening. The shells were then evaluated after approximately 1 week chilled storage.

### Results

A summary of the findings is presented as follows.
Oysters must be positioned correctly (ideally above the horizontal, e.g. in an upright position) when grinding to ensure minimal or no liquor loss
There is variability in the ground hole size and shape depending on the shape of the oyster
The bottle sealing wax does seal the oyster but is removed easily
There were no issues of burnt or damaged oysters
There were no apparent issues with oyster mortalities after 1 week chilled storage

### Study 2

This study was carried out to further test the grinding method, cable tie insertion (as tag analogue) and effectiveness of resealing with a bottle sealing wax (Lordell Trading) using two sizes of oysters: bistro and plate.

### Method

The same grinding, tagging and wax application were used as in Study 1.

### Results

A summary of the findings is presented as follows.
The wax took approximately 60 seconds to fully solidify when applied to the shell
Bistro oysters were smaller and seemed to be a better shape than the Plate oysters and did create a better seal with the wax
No apparent oyster mortalities
It was noted that the point of tag insertion was weak and broke under minor impact
The potential lack of robustness of the wax as an adhesive was noted.

### Study 3

This study was to test a revised grinding method, cable tie insertion (as tag analogue) and effectiveness of resealing with a bottle sealing wax (Lordell Trading) using a revised method of application.

### Method

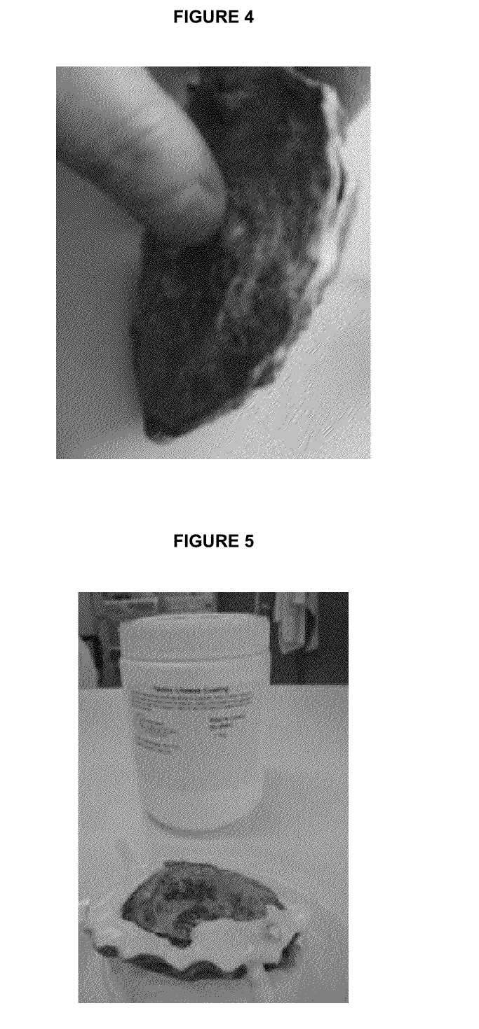

Grinding: The position of the ground opening of Studies 1 and 2 was changed for this study so that it was not located at the top of the oyster but was located directly opposite the hinge on the right hand-side of the oyster (FIG. 4). This position represents the ventral or posterior edge of the oyster shell. The oyster shell was ground in the same manner as in Studies 1 and 2 but with the position of the grinding changed (as indicated above). The change in position of the ground opening was to allow better access to the interior of the mollusc so as to sever the adductor muscle from the shell when shucking the oyster.

Wax application: The wax was melted and applied with a brush as in previous studies 1 and 2 but more wax was applied in an attempt to gain a better, more robust seal.

The oysters were evaluated at day 0 for assessing wax sealing and ease of shucking and again after approximately 1 week chilled storage.

### Results

A summary of the findings is presented as follows.
The quantity of wax used was larger than in Studies 1 and 2 and gave a messy visual appearance to the oyster
All tags and wax plugs were able to be easily removed
After 1 week chilled storage all oysters had a fresh odour and none showed any signs of burn or trauma to the fleshy part of the oyster
No oysters exhibited obvious signs of shell grounds within the cavity
All oysters were easily shucked, the hole position was advantageous for severing the adductor muscle.

The bottle sealing wax used in Studies 1 to 3 was easily removed and therefore may not withstand integrity during transportation. Furthermore, the bottle sealing wax is not approved for direct food contact. For this reason, alternative sealing materials were trialled in the following studies.

### Study 4

This trial was to test the sealing of ground oyster shells with cheese-coating grade polyvinyl acetate (PVAc) and High Density Polyethylene (HDPE) (both food grade materials).

### Method

The grinding of the oyster was carried out as in Study 3. The cheese-coating grade PVAc (Cheeselinks) was a white liquid at room temperature and was directly applied to the oyster with a spoon. However due to the thin viscosity of the PVAc, it was difficult to contain the material so most of the shell was covered (FIG. 5). The HDPE form was solid plastic beads at room temperature and these were melted at 200° C. in a domestic oven prior to use.

### Results

A summary of the findings is presented as follows.
After several days chilled storage, the PVAc had become slightly translucent. On inversion however, the oyster shells remained water tight
After 2 hours at room temperature the PVAc seal failed. The liquid within the shell appeared cloudy probably indicating the PVAc had partially dissolved into the water within the shell
Further investigation determined that this PVAc material was diluted with another substance and that a pure form of PVAc needed to be tested
The HDPE solidified immediately on removal from the oven and could not be applied to the oyster. It would need to be applied to the oyster at close to 200° C. to be able to trial the sealing properties effectively.

### Study 5

This trial was to test the effectiveness of shrink wrap film in sealing the ground oyster shell.

### Method

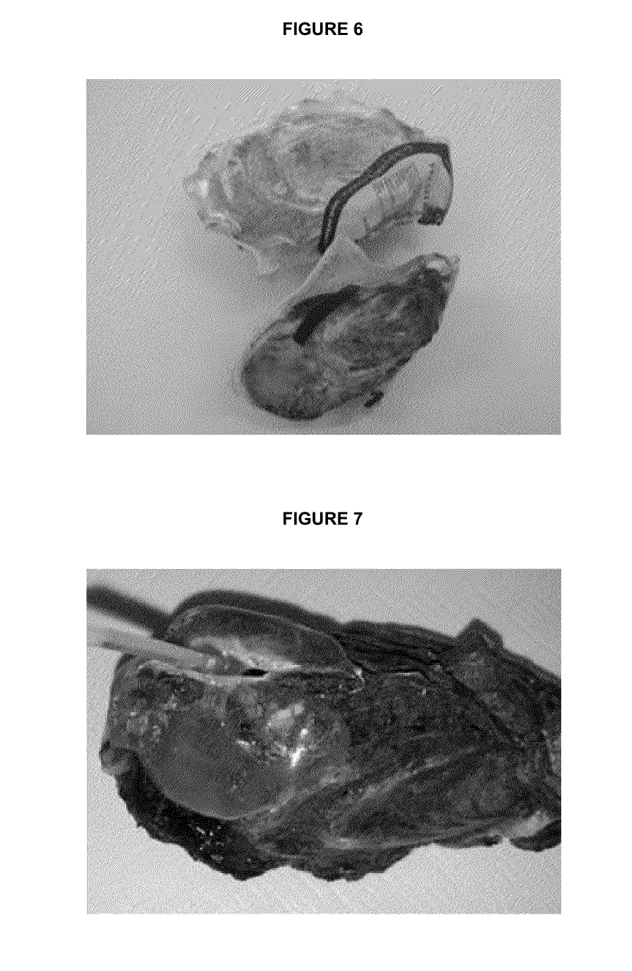

The grinding of the oyster was carried out as shown in Study 3. A commercial shrink wrap film was obtained from a local food business. The shrink film was placed around the ground (with hole) oyster and placed in hot water for a few seconds to shrink the film into place (FIG. 6).

### Results

A summary of the findings is presented as follows.
The shrink film did form a seal around the oyster. The tightness of the seal in preventing liquor leakage during transport and over shelf life was not tested.

### Study 6

This trial was to test the sealing and shelf-life of oysters with three different non-food grade hot-melt adhesives; HB Fuller HM 0038C, HB Fuller Clarity PHL 4167 C ZP, and HB Fuller Advantra PHC 9254.

### Method

The oysters were ground to prepare an opening as per the method in Study 3. The three glues were melted in individual non-stick pots on the stovetop. Once molten, each glue was applied to the shell around the ground opening to fix the cable tie in place and to seal off the opening. The oysters were stored in chilled conditions and evaluated after 1 week.

### Results

A summary of the findings is presented as follows.
No oysters smelled off, none looked damaged (body), and none showed signs of glue within the shell cavity
The Advantra glue had 4 of 8 oysters that leaked (with manual inversion) after 1 week storage
1 out of 8 oysters leaked with the Clarity glue and none were found to leak with HM 0038C glue
In all cases the tag remained attached during storage
2 oysters with Advantra glue exhibited shell fragments within the cavity
All of the samples had seawater remaining in the cavity after storage, though some had less than others
There were no apparent oyster mortalities
Glue HM 0038C was the gluechosen for progression into more extensive trials.

### Study 7

This trial was to test the capability of gum (commercial chewing gum) to seal the ground opening of the oyster shell, and to test the ease of removal of the seal at the time of shucking.

### Method

The oysters were ground to prepare an opening as per the method in Study 3. The gum was softened in hot water. The gum was applied and pressed to the shell around the ground opening to seal. The shells were then stored overnight in chilled storage and evaluated the next day.

### Results

A summary of the findings is presented as follows.
All oysters had gum which was easy to remove and shuck the oyster.
No traces of gum were found within the oyster cavity and no oysters were found to be burnt
The gum flavour had imparted some aroma on the oysters (minty).

### Study 8

This trial was to test the sealing performance and subsequent shelf life of oysters sealed with Oppanol B12 (55,000 MVV) blended with different quantities of paraffin wax and Clarity PHL 4167 CZP hot-melt adhesive.

### Method

Seven adhesive blends of paraffin wax (Fowlers Vacola) and Oppanol B12 (BASF) (0%, 5%, 9%, 17%, 23%, 29% and 33% paraffin wax, with the remainder Oppanol B12) were created by manually kneading the paraffin wax and Oppanol B12 until well combined. The oysters (mix of sizes including bistro, plate, standard and large) were ground to prepare an opening as per the method of Study 3. The adhesive seals were applied over the ground openings at room temperature or after melting over low heat. The oysters were stored at 4° C. and evaluated after 1 week.

### Results

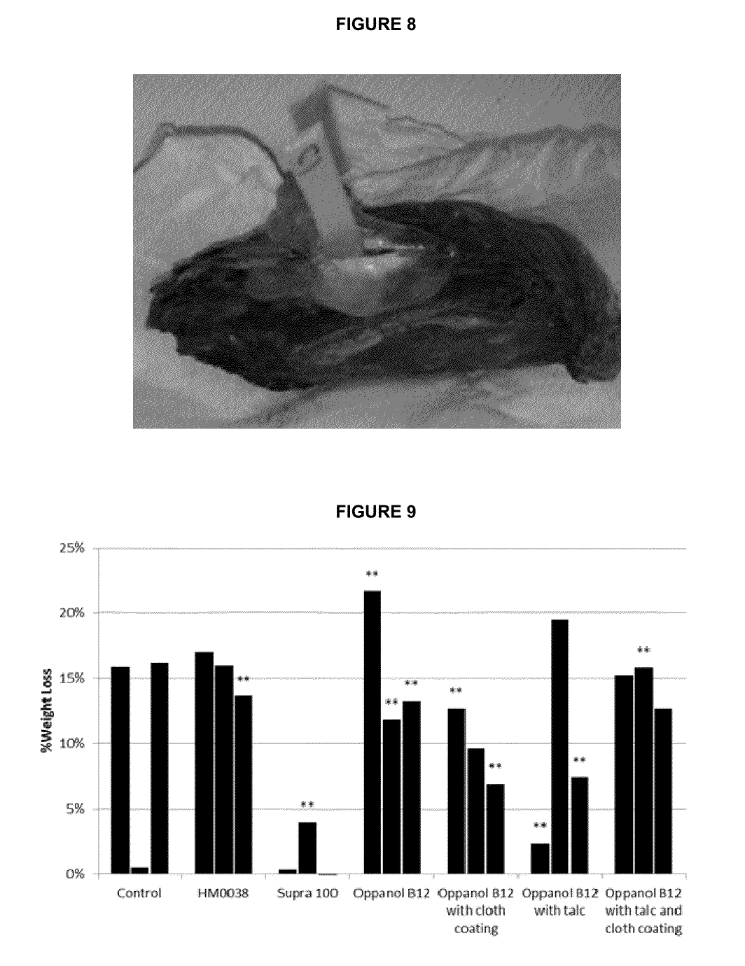

A summary of the findings is presented as follows.
The blends of 17%, 23%, 29% and 33% paraffin wax were of low tack and did not adhere to the oysters. These oysters did not proceed to the storage trial
The blends of 0%, 5% and 9% paraffin wax seals were of high tack and proceeded to the storage trial
After 1 week of storage at 4° C. the oysters were not gapping and there were no oyster mortalities. However, some of the seals made with blends of 0%, 5% and 9% paraffin wax were compromised as they did not remain intact on the oysters (see highlighted region in FIGS. 7 and 8)
The addition of the paraffin wax to the Oppanol B12 did not reduce cold-flow and in some cases Oppanol B12 was observed inside the oyster shells. Oppanol B12 could be blended with a range of other materials to minimise or eliminate cold-flow.

### Study 9

This trial was to test the sealing performance and subsequent shelf life of the oysters sealed with two hotmelt adhesive treatments, Supra 100 (Henkel) and HM0038C (HB Fuller), and four Oppanol B12 treatments, 100% Oppanol B12, 100% Oppanol B12 with a protective cloth coating, Oppanol B12/talc blend, and Oppanol B12/talc blend with a protective cloth coating.

### Method

Oysters (standard size) were scrubbed clean and a portion of the shell was ground to prepare an opening as per the method of Study 3. The treatment adhesive seals were melted over low heat and applied to the ground openings in triplicate. The oysters were stored at 4° C. and evaluated after 1 week. The weights of the oysters were measured and the weight loss determined throughout the trial.

### Results

A summary of the findings is shown in FIG. 9 and presented as follows.
Some oysters were observed to leak liquor when inverted and gently shaken. Leakage did not always correspond to increased weight loss
HM0038C treatments had a high weight loss and one replicate leaked. However, HM0038C does not have the necessary FDA approval for direct food contact. It is approved for 21CFR 175.105 (indirect adhesive)
Supra 100 treatments had very low tack once solidified and resulted in the lowest percent weight loss. However one of the replicates leaked and Supra 100 may not have the necessary FDA approval for direct food contact. It is approved for 21CFR 175.105 (indirect adhesive), 21CFR 176.170 (direct, components of paper and paperboard in contact with aqueous and fatty foods) and 21CFR 176.180 (direct, components of paper and paperboard in contact with dry foods). Furthermore the inflexibility of the Supra 100 once solidified could result in problematic dislodgement of the seal
Most of the Oppanol B12 treatments leaked. The cloth coating was of no assistance. The seals from the Oppanal B12 with cloth coating and Oppanol B12/talc blend treatment exhibited cold flow.

### Study 10

This trial was to test the sealing performance of polyvinyl acetate (PVAc) and 70% PVAc-30% Oppanol B12 blend.

### Method

Oysters were scrubbed clean and a portion of the shell was ground to prepare an opening as per the method of Study 3. The treatment seals were melted over low heat and applied to the ground openings in triplicate. The oysters were stored at 4° C. and evaluated after 1 week.

### Results

A summary of the findings is presented as follows.
PVAc can be supplied with direct food contact approval; however it did not bond to the oyster shells.
Incorporation of 30% Oppanol B12 into the PVAc did not significantly increase the level of tack or seal performance.
PVAc could be blended with a range of other materials to improve the tack.

### Study 11

This trial was to test the sealing performance and subsequent shelf life of oysters sealed with a range of pressure sensitive adhesives and food contact materials.

### Method

Oysters (mix of standard and large sizes) were cleaned and a portion of the shell was ground to prepare an opening as per the method of Study 3. Tags were not inserted into any of the ground openings. The pressure sensitive adhesives included a RH1FG self-adhesive label (approved for fruit and vegetables, UPM Raflatac), 4388 self-adhesive label (designed for freezer applications, Herma), 10000 self-adhesive label (designed for removable applications, Herma) and a pressure-sensitive adhesive, GD31 (glue-dots—approved for 21CFR 175.105 adhesives and 21CFR 175.125 direct food contact). A two-stage Oppanol B12 plug followed by a bottle sealing wax dip, and strips of silicon bakeware held in place by a rubber band were also trialled. The oysters were stored at 4° C. and evaluated after 1 week. The weights of the oysters were measured and the weight loss determined throughout the trial.

### Results

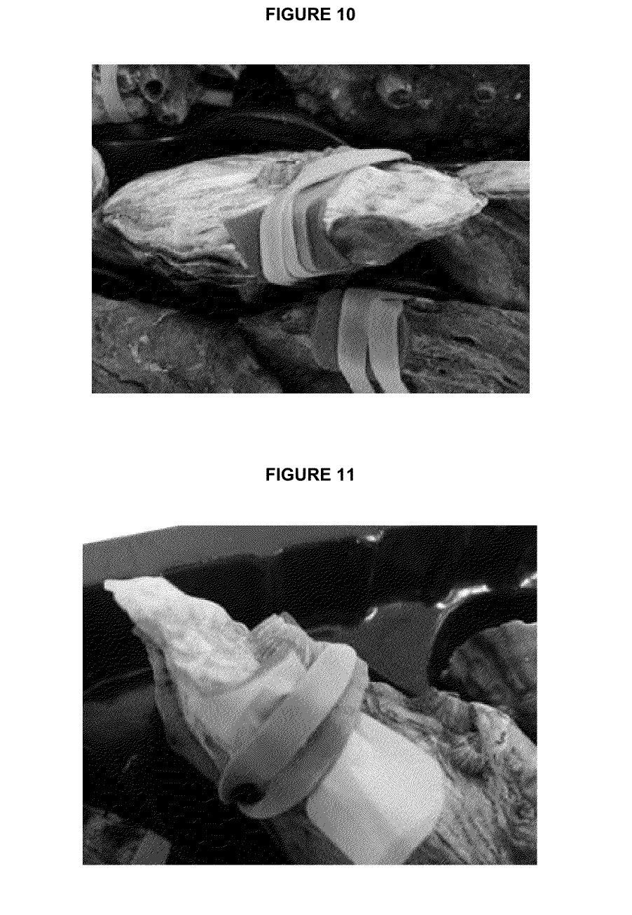

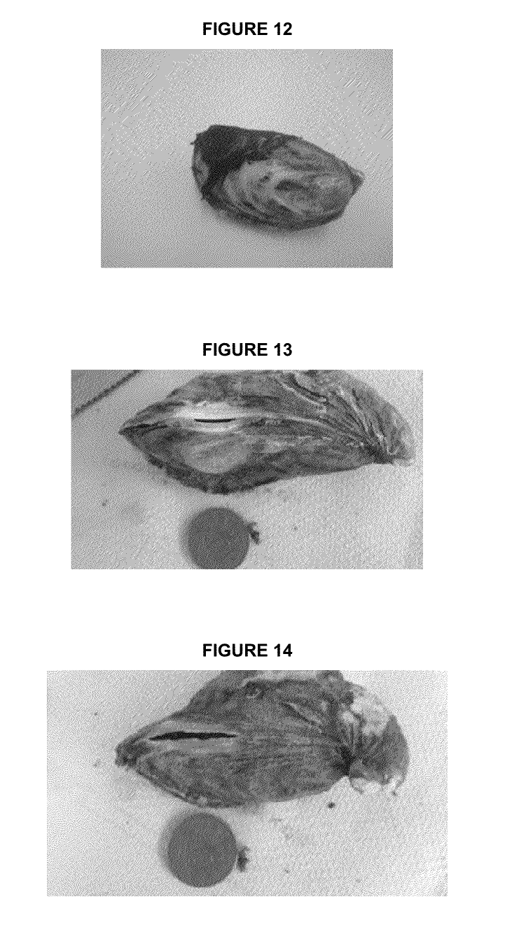

A summary of the findings is presented as follows.
The RH1FG, 4388 and 10000 self-adhesive labels failed to adhere to the oyster shell and these treatments were removed from the storage trial
The silicon bakeware held in place by a rubber band (FIG. 10) was successful in preventing any fluid leakage and indicates that a glue/adhesive is not essential in forming a fluid tight seal
The GD31 gluedots failed to adhere to the oyster shells, but could be held in place with some backing paper and a rubber band (FIG. 11)
With respect to the two-stage Oppanol B12-wax treatment, Oppanol B12 was sufficient to initially plug the ground opening and subsequent addition of the wax appeared to contain the Oppanol B12 and stop it from flowing over the outside of the oyster (FIG. 12). However, Oppanol B12 was found inside some of the oyster cavities. The addition of a tag may help prevent the Oppanol B12 from being able to flow inside the oyster cavity.

### Study 12

This trial was to test the suitability of commercial cheese-waxes as an appropriate sealing material.

### Method

Oysters (mix of standard and large sizes) were cleaned and a portion of the shell was ground to prepare an opening as per the method of Study 3. Samples of commercial cheese-waxes were sourced and physical properties (tack, viscosity, hardness) and ability to be blended with Oppanol B12 were investigated.

### Results

A summary of the findings is presented as follows.
Cheese-wax samples were sourced from Sonneborn and Sasol. Both cheese-waxes were soft at room temperature and exhibited some tack. When molten the cheese-waxes have a very low viscosity and under chilled conditions they hardened and tack reduced.
The cheese-waxes could be blended with Oppanol B12. Increasing the concentration of Oppanol B12 resulted in a higher tack, higher viscosity material. Blends containing 10, 20 or 30% Oppanol B12 appeared more favourable.

### Study 13

This trial was to test the sealing performance of 10% and 30% Oppanol B12 blended with bottle sealing wax, Sonneborn cheese-wax, or Sasol Cheese-wax.

### Method

Oysters (plate size) were scrubbed clean and a portion of the shell was ground to prepare an opening as per the method of Study 3. The treatment adhesive seals were melted over low heat and applied to the ground openings in triplicate. The oysters were then dipped in cold water and stored at 4° C. and the seal performance evaluated after 12 days.

### Results

A summary of the findings is presented as follows.
30% Oppanol B12 blended with Sonneborn cheese-wax outperformed the other treatments

### Study 14

This trial was to test the sealing performance and integrity of five cheese-wax/PIB blends by spoon application.

### Method

Triploid oysters were used for this study. A portion of the shell was ground to prepare an opening as per the method of Study 3. Seals were prepared by melting either Sonneborn or Paramelt cheese-waxes and blended with Opponal B10 or Oppanol B12 polyisobutylenes. The molten compounds were applied over the ground opening and the oysters dipped into potable cool water for a short period of time to facilitate hardening of the wax. The oysters (1 dozen per treatment) were placed into plastic bags and stored at 4° C. Seal performance was assessed after 2 days.

The composition of the seals were:
75% Sonneborn cheese-wax and 25% Opponal B12
70% Sonneborn cheese-wax and 30% Opponal B12
65% Sonneborn cheese-wax and 35% Opponal B12
70% Paramelt cheese-wax and 30% Oppanol B12
70% Paramelt cheese-wax and 30% Oppanol B10

### Results

A summary of the findings is presented as follows.
8.3-16.7% of the sealed oysters failed (irrespective of the treatments)
All remaining seals did not leak but were easily dislodged.

### Study 15

This trial was to test the sealing performance and integrity of five cheese-wax/PIB blends by dip coating at different temperatures.

### Method

Triploid oysters were used for this study. A portion of the shell was ground to prepare an opening as per the method established Study 3. Seals were prepared by melting Sonneborn cheese-wax blended with Oppanol B12 polyisobutylene. The oysters were dipped into the molten compounds before being dipped into potable cool water for a short period of time to facilitate rapid hardening of the wax blend. The oysters (½ dozen per treatment) were placed into plastic bags and stored at 4° C. Seal performance was assessed after 2 days.

The composition and application conditions of the seals were:
100% Sonneborn cheese-wax, dipped 2× at >80° C.
100% Sonnenborn cheese-wax, dipped 2× at −61° C.
70% Sonneborn cheese-wax and 30% Opponal B12, dipped 2× at −122° C.
70% Sonneborn cheese-wax and 30% Opponal B12, dipped 1× at −84° C.
70% Sonneborn cheese-wax and 30% Opponal B12, dipped 1× at −70° C.

### Results

A summary of the findings is presented as follows.
100% cheese-wax applied at >80° C.—very thin and delicate coating which cracked around some of the oyster shells. The wax could not be easily removed.
100% cheese-wax applied at ˜61° C.—thicker coating that retained its integrity. This method of re-sealing (100% cheese-wax applied at a temperature just above the congealing point) provided ideal performance and the wax was easy to prepare.
70% cheese-wax/30% B12 applied at ˜122° C.—integral seal could not be formed due to release of air bubbles (presumably from air expansion associated to the high application temperature).
70% cheese-wax/30% B12 applied at ˜84° C.—integral seal could not be formed due to release of air bubbles (presumably from air expansion associated to the high application temperature).
70% cheese-wax/30% B12 applied at ˜70° C.—seal formed but was not as visually appealing as the concepts with 100% cheese-wax.

### Study 16

Prior to re-sealing the ground oysters liquor loss needs to be minimised as this will impact on subsequent oyster quality and shelf life. In the laboratory this has been managed by carefully controlling the size of the ground opening and/or by ensuring that the opening remains above a horizontal position (e.g. in an upright position) until the oysters are re-sealed. The objective of this trail was to determine the extent of liquor loss during the handling and processing of the ground oysters.

### Method

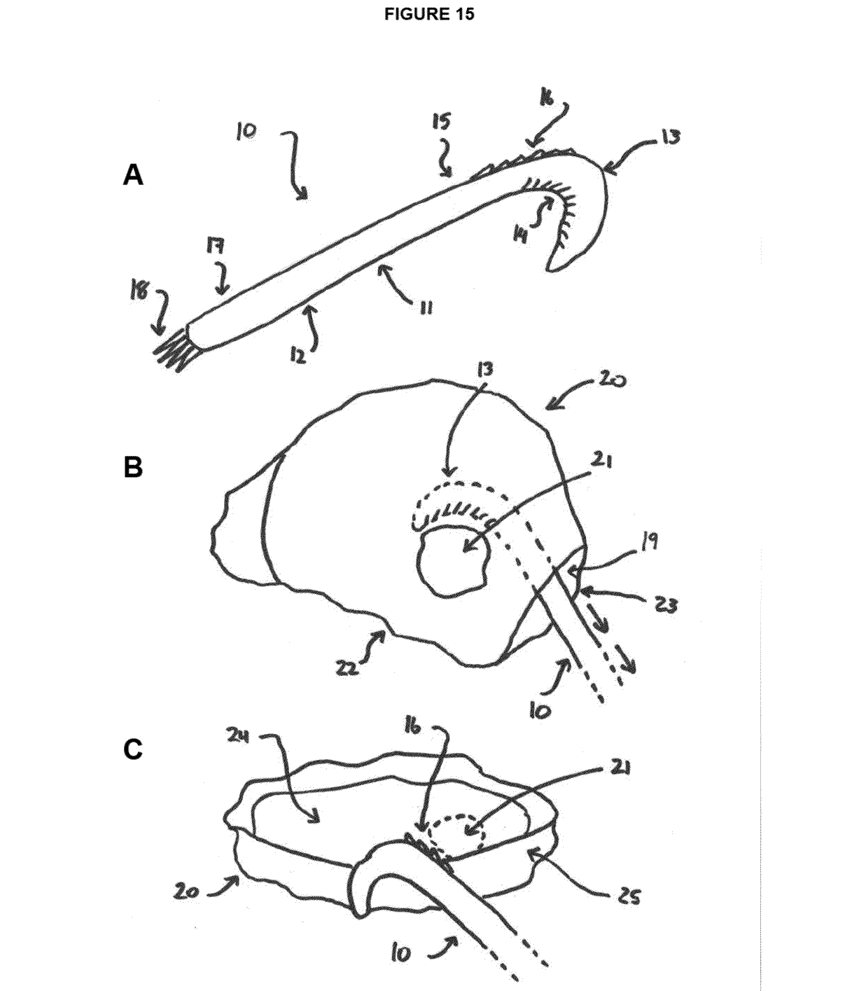

Twelve oyster shells were ground to obtain an opening in the shell as per the method developed in Study 3. The size of the opening was either small (FIG. 13—approximately 15 mm×1 mm) or large (FIG. 14—approximately 27 mm×2.5 mm). The oysters were inverted for 5 seconds above a piece of paper towel and held steady or moderately shaken. The quantity of liquor release was observed.

### Results

A summary of the findings is presented as follows.
The small ground opening did not result in any drip loss when inverted; however, when shaken a few drips or a continuous slow rate of dripping was observed.
The larger ground opening generally resulted in a continuous slow rate of dripping when inverted and a continuous flow when shaken. P1 The ability of the liquor to form a meniscus was reduced as the size of the ground opening increased and vibrations increased liquor loss. Accordingly, the oysters may need to be kept in a position such that the ground opening is at least above the horizontal (e.g. in an upright position) until the ground opening is at least partially sealed.

### Study 17

Controlling the position of the ground opening during sealing could be more difficult in scaled-up processing. The objective of trial was to examine the suitability of a 2-stage wax application process to minimise liquor loss.

### Method

Oysters (day of harvest+5 days) were used for this trial. A proportion of the oyster shells were ground to prepare an opening as per method of Study 3. The size of the opening was approximately 27 mm×2.5 mm. Seals were prepared by melting yellow Sonneborn cheese-wax and allowing this wax to cool to approximately 65° C. (just above its congealing point). Oysters (1 dozen per treatment) were re-sealed as outlined below. The re-sealed oysters were then dipped into potable cool water for a short period of time to facilitate hardening of the wax before being placed into plastic bags and stored at 4° C. Seal performance was assessed after an additional 8 days of storage (day of harvest+13 days).

The seal applications that were trialled are as follows:
Oysters inverted and dipped once into molten wax
Oysters inverted and dipped twice into molten wax
Oysters kept upright and molten wax poured over ground opening. Partially/fully sealed oyster then inverted and dipped once into molten wax
Control—oysters were not ground

### Results

A summary of the findings is presented as follows.
Oysters inverted and dipped once—50% of oysters had pinprick sized holes in wax. Wax was quite thin and difficult to remove. Liquor could be seen underneath wax. 8.3% of oysters had lost nearly all of their liquor from the cavity.
Oysters inverted and dipped twice—8.3% of oysters had pinprick sized holes in wax. Wax was thicker and easier to remove. Liquor could be seen underneath wax. A significant amount of liquor remained inside the cavity of all the oysters.
Oysters kept upright, molten wax poured over opening and then inverted and dipped once—all seals retained their integrity. Wax was relatively easy to remove. Liquor could be seen underneath wax. A significant amount of liquor remained inside the cavity of all the oysters. This method of re-sealing was ideal as it reduced the risk of liquor escaping from the ground opening.
Control—oysters not ground—50% of the oysters had lost nearly all of their liquor from cavity and 33% of the oysters were gaping after 13 days. The control group had reached the end of their shelf-life. The typically shelf-life of a whole life oyster is around 10 days.

### EXAMPLE 3

### Mollusc Removal Tool

The method of the present invention provides a mollusc that is “easy-opening” for the consumer. The opening of a mollusc prepared by the method of the present invention involves insertion of a tool into the exposed interior of the mollusc. The tool can be used to sever the adductor muscle or muscles of the mollusc or can be used to leverage each valve of the shell of the mollusc apart prior to and/or after severing of the adductor muscle. An exemplary tool and its mechanism of action is shown in FIG. 15 with reference to an oyster.

According to FIG. 15A, an exemplary tool 10 has an elongated body 11 with one end 12 that can be held by the consumer. A first portion 13 of the tool 10 can be inserted into the exposed interior of the oyster and is in the form of a hook that includes a serrated or sharpened edge 14 positioned on an inner portion of the hook 13. At a second portion 15 of the tool 10 there is included a serrated or sharpened edge 16. At a third portion 17 of the tool 10 there is included a fork-like arrangement 18. In use (as shown in FIG. 15B), the first portion 13 of the tool 10 is inserted into the exposed interior 19 of the oyster 20 so that the inner portion of the hook 13 encircles a portion of the adductor muscle 21 of the oyster 20. The user then pulls the tool 10 out of the oyster 20 in the direction of the arrows such that the serrated or sharpened edge 14 of the inner portion of the hook 13 severs the adductor muscle 21 as the tool is being pulled out. The top valve of the shell of the oyster 21 may then be removed, for example by using the tool 10 to leverage each valve apart from the other. The position of the adductor muscle 21 relative to the dorsal edge 22 and posterior edge 23 of the oyster 20 are shown in FIG. 15B. In this embodiment, the interior of the oyster 20 has been exposed at the posterior edge 23 that is located closest to the adductor muscle 21. As shown in FIG. 15C, once the top valve of the shell of the oyster 20 has been removed, the oyster meat 24 will remain attached to the adductor muscle 21 of the bottom valve 25 of the shell of the oyster 20. The oyster meat 24 can be separated from the adductor muscle 21 using the serrated or sharpened edge 16 of the second portion 15 of the tool 10. In this regard, the serrated or sharpened edge 16 can be slipped under the oyster meat 24 to sever the adductor muscle 21. The oyster meat 24 can then be readily consumed, for example by picking the oyster meat 24 up using the fork-like arrangement 18 of the tool 10.

Those skilled in the art will appreciate that the invention described herein is susceptible to variations and modifications other than those specifically described. It is to be understood that the invention includes all such variations and modifications. The invention also includes all of the steps, features, compositions and compounds referred to, or indicated in this specification, individually or collectively, and any and all combinations of any two or more of the steps or features.

Future patent applications may be filed in Australia or overseas on the basis of the present application, for example by claiming priority from the present application, by claiming a divisional status and/or by claiming a continuation status. It is to be understood that the following provisional claims are provided by way of example only, and are not intended to limit the scope of what may be claimed in any such future application. Furthermore, the claims should not be considered to limit the understanding of (or exclude other understandings of) the invention inherent in the present disclosure. Features may be added to or omitted from the provisional claims at a later date, so as to further define the invention.

1. A method of preparing a bivalve mollusc to facilitate subsequent opening of the mollusc, the method including:
exposing the interior of the mollusc; and
applying a seal to the exposed interior, wherein the seal maintains integrity of the mollusc prior to subsequent opening.

2. The method of claim 1, wherein the interior of the mollusc is exposed by removing a portion of the shell of the mollusc by milling, grinding, drilling, nipping, cutting or slicing the shell.

3. (canceled)

4. The method of claim 1, wherein the interior of the mollusc is exposed at the dorsal or posterior edge of each valve of the shell of the mollusc.

5. (canceled)

6. The method of claim 4, wherein the dorsal or posterior edge of each valve of the shell of the mollusc is the dorsal or posterior edge located closest to the adductor muscle of the mollusc.

7. (canceled)

8. The method of claim 1, wherein the interior of the mollusc is exposed via an opening of at least 1 mm.

9. The method of claim 1, wherein the seal minimises or eliminates leakage of liquor from the mollusc, prevents contamination of the mollusc, and/or maintains the shelf-life of the mollusc compared to an untreated mollusc.

10. The method of claim 1, wherein the seal is a wax-based seal.

11. The method of claim 10, wherein the wax-based seal includes cheese-wax, and optionally also includes polyisobutylene.

12. (canceled)

13. The method of claim 11, wherein the wax-based seal includes about 70% cheese-wax and about 30% polyisobutylene.

14-15. (canceled)

16. The method of claim 10, wherein the wax-based seal is applied to the exposed interior of the mollusc in a molten state.

17. (canceled)

18. The method of claim 1, wherein the method further includes the step of applying a second seal over the seal that has been applied to the exposed interior of the mollusc.

19. The method of claim 18, wherein the second seal is a wax-based seal.

20. The method of claim 19, wherein the wax-based seal includes cheese-wax, and optionally also includes polyisobutylene.

21. (canceled)

22. The method of claim 20, wherein the wax-based seal includes about 70% cheese-wax and about 30% polyisobutylene.

23. (canceled)

24. The method of claim 19, wherein the wax-based seal is applied in a molten state.

25. The method of claim 1, wherein the subsequent opening involves removing, piercing and/or breaking of the, or each, seal and insertion of a tool into the exposed interior of the mollusc, wherein the tool enables severing of the adductor muscle of the mollusc thereby allowing opening of the mollusc.

26-34. (canceled)

35. The method of claim 1, wherein the mollusc is selected from the group consisting of an oyster, a clam, a scallop and a mussel.

36. A bivalve mollusc prepared by the method of claim 1.

37. A combination product including a bivalve mollusc prepared by the method of claim 1, and a tool which can be inserted into the exposed interior of the mollusc, wherein the tool enables severing of the adductor muscle of the mollusc.

38-46. (canceled)

47. A tool for use in the method of claim 25, wherein the tool can be inserted into the exposed interior of the mollusc and can severe the adductor muscle of the mollusc.

48-56. (canceled)
